(19) United States
(12) Patent Application Publication
(10) Pub. No.: US 2007/0282026 A1
(43) Pub. Date: Dec. 6, 2007

(54) Low-Odor Catalyst for Isocyanate-Derived Foams and Elastomers

(75) Inventors: Robert A. Grigsby Jr, Spring, TX (US); Robert L. Zimmerman, Austin, TX (US); Ernest L. Rister, Round Rock, TX (US); Jennifer K. Pratt, Georgetown, TX (US)

Correspondence Address: Legal Department;Huntsman Corporation, 10003 Woodloch Forest Drive, The Woodlands, TX, 77380, US

(73) Assignee: Huntsman Petrochemical Corporation, The Woodlands, TX (US)

(21) Appl. No.: 10/565,521

(22) PCT Filed: Jul. 22, 2004
(86) PCT No.: PCT/US04/23361

§ 371 Date: May 8, 2007

Related U.S. Application Data
(60) Provisional application No. 60/489,985, filed on Jul. 24, 2003.

(51) Int. Cl. B01J 31/18; C08G 18/06; C08G 18/08; C08G 18/10; C08G 18/18; C08G 18/28; C08G 18/48; C08J 9/00; C09K 3/00

(52) U.S. Cl. 521/65; 502/167; 521/189

(57) ABSTRACT

Provided herein are catalysts useful in providing foam products which are produced using an organic poly isocyanate as a starting material. A catalyst according to the present invention includes the tris-(hydroxyethyl)methyl ammonium cation, and optionally potassium cation, in combination with a variety of possible counter anions present to maintain charge balance and for compatibility. A catalyst according to the invention is preferably used in conjunction with one or more conventional tertiary amine catalysts in a foam producing process. The foams may be polyurethane foams, polyisocyanurate foams, flexible foams, or elastomeric foams.

### CROSS-REFERENCES TO RELATED APPLICATIONS

This application claims priority to U.S. patent application Ser. No. 60/489,985 filed Jul. 24, 2003 which is currently still pending.

### TECHNICAL FIELD

The present invention relates to catalyst compositions and foams produced using the catalysts in reactive processes which employ one or more isocyanates as a raw material. More particularly the catalysts are quaternary ammonium compounds useful in the production of polymeric foams and elastomers.

### BACKGROUND INFORMATION

A large number of chemical substances have been identified which alter the curing reaction kinetics in reactive systems that include one or more organic polyisocyanates as a reactant, in addition to the physical properties of the final polymer materials produced, and some of these substances are catalytic in nature. Polyurethanes, polyureas, and poly-isocyanurates are all materials produced using a polyisocyanate as a reactant, and a survey of the prior art reveals volumes of patents in the field of polyurethane, polyurea and polyisocyanurate polymers. For example, U.S. Pat. No. 3,980,594 describes the trimerization of aromatic isocyanates catalyzed by certain ammonium salts. Quaternary ammonium salts or inorganic and organic oxygen acids having pK values for at least one of the dissociable hydrogen atoms equal to or greater than 2.0 in aqueous solution are employed as extremely efficient catalysts for trimerization of organic isocyanates, particularly aromatic isocyanates, to isocyanurates and for urethane formation. U.S. Pat. No. 4,521,545 describes the latent catalyst made from an amine and a alkylating ester of an acid of phosphorous. U.S. Pat. No. 4,582,861 describes the use and synthesis of N-hydroxyalkyl quaternary ammonium carbonate salt. U.S. Pat. Nos. 4,785,025 and 4,904,629 describe the use and synthesis of salts based on TEDA. Thus, quaternary ammonium salts have been known to function as catalyzing trimerization of isocyanates at the back end of the reaction. Typically, they are made from a starting material of trimethyl amine, which has a very strong amine odor. These salts may include an anion which may be derived from various acids.

In the polyurethane industry there is a need for a delayed action catalyst, i.e. a catalyst that will delay the onset of the isocyanate-polyol reaction (“initiation time”) while not substantially affecting the time to the end of the reaction or final cure, or that will yield the same initiation time with a shorter cure time. The problem is manifested in the production of polyurethane shoe soles where it would be desirable if the polyurethane forming composition would not begin to react until it has essentially filled the mold form while also reaching a final cured state in substantially the same or shorter time period to maintain productivity.

Past attempts to solve this problem have centered around taking the standard amine catalyst, i.e. triethylenediamine, and blocking it with an acid to form the simple amine salt. In theory, this approach should work well but from experimentation it failed to delay the initiation time as desired without lengthening the cure time. U.S. Pat. No. 4,582,861 describes the use and synthesis of N-hydroxyalkyl quaternary ammonium carbonate salt as a remedy to this problem.

### SUMMARY OF THE INVENTION

The present invention is directed to a process for producing an elastomer, PIR, or PUR foam product by reaction of an organic isocyanate and a polyol in the presence of a tertiary amine catalyst, and the improvement according to the invention is effected by conducting the reaction further in the presence of a compound which contains tris-(hydroxyethyl)methyl ammonium cation. According to one embodiment, the compound which contains tris-(hydroxyethyl)methyl ammonium cation is present in an amount of at least 40% by weight, based on the weight of the tertiary amine present in the composition from which the foam product is produced. Charge counterbalance for the tris-(hydroxyethyl)methyl ammonium cation in the compound may be provided by the presence of an ion selected from the group consisting of: hydroxide ion, carbonate ion, bi-carbonate ion, chloride ion, bromide ion, a C₁-C₂₀ carboxylate anion, di-hydrogen phosphate anion, mono-hydrogenphosphate anion, and phosphate anion. According to one alternate embodiment of the invention, the process is conducted in the presence of any amount of water between about 0.05% and 10.0% by weight based on the total weight of said polyol present, including every hundredth percentage therebetween. According to preferred embodiments of the invention, the tertiary amine is selected from the group consisting of: N,N,N′-trimethyl-N′-hydroxyethyl-bisaminoethylether; bis-(2-dimethylaminoethyl)ether; N,N,N′,N″,N″-pentamethyl-dipropylenetriamine; N,N-dimethylcyclohexylamine; and pentamethyldiethylenetriamine. According to one alternate embodiment, a process according to the invention is conducted in the further presence of potassium ion, wherein potassium is present in any amount between 0.1% and 2.0% by weight based on the total weight of all the components of the composition from which the foam is produced, less the weight of the isocyanate compound(s) employed. According to another alternate embodiment, a process according to the invention is conducted in the further presence of one or more materials known to those skilled in the art falling within the classes of: surfactants, flame retardants, and blowing agents when used in the production of polyurethane elastomers or polyurethane foams, as one of ordinary skill recognizes materials as falling within these classifications from knowledge of prior art foam compositions of commerce and published literature sources, including various published patents and patent applications.

According to another alternate embodiment of the invention there is provided an aqueous solution comprising tris-(hydroxyethyl)methyl ammonium cation, water, and a tertiary amine, wherein water is present in any amount between about 5% and 95% by weight based on the total weight of the aqueous solution and wherein the tris-(hydroxyethyl)methyl ammonium cation is present in any amount between about 1% and 50% by weight based on the total weight of the aqueous solution and wherein one or more tertiary amines are present in any amount between about 2.5 and 75% by weight based on the total weight of the aqueous solution. The tertiary amine in such an aqueous solution may be selected from the group consisting of: N,N,N′-trimethyl-N′-hydroxyethyl-bisaminoethylether; bis-(2-dimethylaminoethyl)ether; N,N,N′,N″,N″-pentamethyl-dipropylenetriamine; N,N-dimethylcyclohexylamine; and pentamethyldiethylenetriamine.

A further embodiment of the invention provides a solution comprising a tris-(hydroxyethyl)methyl ammonium cation-containing compound which includes one or more C₁-C₄₀ carboxylate anions dissolved in an organic solvent selected from the group consisting of: alcohols having between about 1 and about 20 carbon atoms; ethers having between about 1 and about 20 carbon atoms; alkylene glycols; and polyalkylene glycols.

### DETAILED DESCRIPTION

The present invention is directed at including a particular quaternary ammonium cation as part of the catalyst package used in the curing of urethane foams and elastomers which improves isocyanate conversion and decreases the time it takes to complete reaction of the isocyanate with the reactive components, all while preventing strong ammonia-like odors in the foam. Advantages of using the materials of the present invention include the fact that conversion of the isocyanate at lower temperatures occurs when an appropriate trimerization-promoting catalyst is used to catalyze the reaction of the isocyanate with itself or other crosslinkable moieties. The conversion at lower temperatures can in turn shorten the time required of the material to reside in a press, thus enabling faster manufacturing cycle times, improved productivity, and reduced costs. In addition, lower density foam is obtained when tris-(hydroxyethyl)methyl ammonium cation is included in the formulations from which PUR or PIR foams are produced.

A quaternary ammonium salt useful as a co-catalyst according to the present invention contains the tris-(hydroxyethyl)methyl ammonium cation, and also contains an anion for charge neutrality. The structure of tris-(hydroxyethyl)methyl ammonium hydroxide (“THEMAH”) is as shown below: 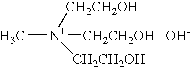
This material may be produced by ethoxylation of methyl-diethanolamine under normal alkoxylation conditions, and is available from Huntsman LLC of Houston, Tex.

In order to provide materials comprising the tris-(hydroxyethyl)methyl ammonium cation whose charge balance is maintained by anions other than hydroxide, a solution of THEMAH may be treated with an acidic substance, in which case the protons from the acidic substance react with the hydroxide ion of THEMAH to yield a molecule of water and the tris-(hydroxyethyl)methyl ammonium salt of the anion of the acid employed. For example, when THEMAH is neutralized with formic acid, tris-(hydroxyethyl)methyl ammonium formate is afforded. When THEMAH is neutralized with acetic acid, tris-(hydroxyethyl)methyl ammonium acetate is afforded. For example, when THEMAH is neutralized with nitric acid, tris-(hydroxyethyl)methyl ammonium nitrate is afforded. For example, when THEMAH is neutralized with sulfuric acid, tris-(hydroxyethyl)methyl ammonium sulfate is afforded, and so forth. Thus, one of ordinary skill readily recognizes that the number of anions which may accompany the THEMA cation is as vast as the number of acids, including all known organic acids and inorganic acids. The stoichiometry of the neutralization between THEMAH and a selected acid, and the simplistic nature of acid/base chemistry means that one of ordinary skill may easily produce any desired quantity in any solvent of any compound containing a tris-(hydroxyethyl)methyl ammonium cation and the anion of an acid selected.

Water and various organic materials are all suitable as solvents in which to carry out such neutralization reactions between THEMAH and one or more acidic substances, including without limitation alcohols having any number of carbon atoms up to about 20; ethers having any number of carbon atoms up to about 20, glycols, glycol ethers, hydrocarbons, ketones, and esters.

A foam formed using a catalyst according to the present invention can be either a rigid polyisocyanurate (“PIR”) or polyurethane (“PUR”) foam, a flexible foam, and/or an elastomeric foam. One end use application for which the catalyst of the present invention is readily adaptable is the manufacture of boardstock foam. In such an employment, the catalyst according to the present invention assists in converting the excess isocyanate to trimer materials in the foam. A catalyst according to the present invention may be referred to as a “back-end cure” catalyst, since it improves on the curing rate and conversion of the material.

### Preparation of THEMAH Derivatives

Various compounds comprising a tris-(hydroxyethyl)methyl ammonium cation were prepared and are specified in Table I below. All samples were purposefully prepared in diethylene glycol (“DEG”) at such a concentration that the final DEG content would be about 30 wt. %. Each sample was prepared by adding 333.3 grams of a 30% aqueous solution of THEMAH (containing about 0.55 moles of THEMAH) to a DEG solution containing 0.55 moles equimolar amount of the desired acid to a 1 L round-bottom flask. The water present in the THEMAH starting material and the water formed in the reaction was removed from the product using a Buchi Rotovapor rotary evaporator whose water bath was set to 50° C.

According to a process of the invention, a catalyst according to the invention may be used in conjunction or combination with any other amine catalyst known to those skilled in the art to improve on the cure time and shorten the de-mold time of various polyurethane and polyisocyanurate foam and elastomer systems.

TABLE I

| | Sample No. | | | | | |
|---|---|---|---|---|---|---|
| | 1 | 2 | 3 | 4 | 5 | 6 |
| Acid | Oleic | Formic | Decanoic | Acetic | Formic | Formic |
| THEMAH (g) | 100 | 100 | 100 | 100 | 200 | 200 |
| Acid (g) | 102.7 | 16.73 | 63.22 | 21.8 | 63.2 | 63.2 |
| DEG (g) | 68.5 | 31.6 | 51.5 | 34.8 | 33.5 | 33.5 |
| water collected (g) | 30 | 48 | 72 | 37 | 53 | 100 |

Analysis of product

| | | | | | | |
|---|---|---|---|---|---|---|
| Alkalinity, meq/g | 1.508 | 3.397 | 2.074 | 3.127 | 2.818 | 3.249 |
| Water, wt. % | 4.67 | 0.75 | 0.12 | 2.9 | 14.19 | 1.77 |

For the neutralization reactions between THEMAH and carboxylic acid for which quantities of reactants are listed in table I, the THEMAH and DEG were added to a 1000 mL 4-neck round-bottom flask. The carboxylic acid was added slowly to the flask using an addition funnel so that the reaction temperature would not exceed 40° C., and the reaction mixture was stirred for 2 hours. For sample no. 5, water was removed from the product mixture under vacuum distillation conditions (60 mmHg, 80° C.). For sample no. 6, water was removed from the product mixture under vacuum distillation conditions (60 mmHg, 100° C.).

The following example formulations in Table II show the differences in materials produced using THEMAH vs. DABCO TMR-2 catalyst. In these examples, different levels of water were added to each sample so as to keep the amount of water present in each of formulations I-VI constant. The reason different amounts of water are added to each of the formulations in Table III is because the THEMAH is present as an aqueous solution and those samples having more THEMAH initially inherently contain more water attendant to that THEMAH (since it all came from the same stock solution). Hence, addition of these different amounts of added water are necessary to maintain a constant water concentration in all samples to render comparisons between the data to be meaningful, i.e., the samples prepared using THEMAH give the same amount of blowing as the examples prepared using DABCO® TMR-2 catalyst.

TABLE II

| | Formulation | | | | | |
|---|---|---|---|---|---|---|
| | I | II | III | IV | V | VI |
| Stepan STEPANOL ®PS-2412 polyol | 100 | 100 | 100 | 100 | 100 | 100 |
| PELCAT ® 9540a cat | 4.2 | 4.2 | 4.2 | 4.2 | 4.2 | 4.2 |
| PELRON Pel-Sil 9900 surfactant | 2.0 | 2.0 | 2.0 | 2.0 | 2.0 | 2.0 |
| THEMAH | 0.25 | 0.5 | 0.75 | — | — | — |
| DABCO TMR-2 catalyst | — | — | — | 0.25 | 0.50 | 0.75 |
| Water | 0.375 | 0.25 | 0.125 | 0.5 | 0.5 | 0.5 |
| Pentane | 21 | 21 | 21 | 21 | 21 | 21 |
| RUBINATE ® 1850 isocyanate | 300 | 300 | 300 | 300 | 300 | 300 |

Rise profile

| | | | | | | |
|---|---|---|---|---|---|---|
| Cream time, sec | 9 | 8 | 8 | 9 | 9 | 9 |
| Top of Cup, sec | 23 | 18 | 19 | 21 | 21 | 19 |
| Gel time, sec | 34 | 26 | 25 | 30 | 30 | 28 |
| Tack free time, sec | 44 | 39 | 38 | 40 | 38 | 40 |
| Rise time, sec | 77 | 66 | 64 | 71 | 73 | 66 |
| Firm time, sec | 97 | 94 | 83 | 94 | 94 | 84 |
| Free rise density, g/ml | 1.53 | 1.57 | 1.65 | 1.69 | 1.70 | 1.74 |

Thus, foams produced in the presence of THEMAH have lower density than when DABCO TR-52 catalyst is employed. DABCO TR-52 catalyst is generally regarded by those skilled in the art as a typical good “back-end” cure catalyst.

TABLE III

| COMPONENTS | PARTS BY WEIGHT | control |
|---|---|---|
| STEPHAN PS-2352 polyol | 100 | — |
| Goldschmidt B-84PI surfactant | 2.0 | — |
| 141B | 16 | — |
| Water | 1.0 | — |
| RUBINATE ®M (3.96 index) | 283.8 | — |
| B-component | 31.8 g | 31.8 |
| A-component (isocyanate) | 75.7 g | 75.7 |
| PELRON ® 9540A | 1.3 g | 1.3 |
| THEMAH | 0.5 g | 0 |
| Cream time, seconds | 11 | 12 |
| Rise time, sec | 62 | 59 |
| Tack free time, sec | 34 | 26 |
| Density, g/ml | 2.67 | 3.12 |

Alternative and/or additional reactants useful with THEMAH include: Polyester polyols, polyether polyols, 1,4-butane-diol, mannich polyols, sucrose polyols, surfactants, either organic (carbon) or silicon based, potassium salts of any and all organic and inorganic acids, other amine catalysts, blowing agents such as hydrocarbon, carbon dioxide, FREON® 141B, HFC-245FA.

Another experiment was set up to compare the effect of Huntsman's JEFFCAT® TR-63 catalyst (JEFFCAT® TR-63 is tris-(hydroxyethyl)methyl ammonium formate) in PIR foam versus not having any JEFFCAT® TR-63 catalyst in the foam. We collected ReactFTIR data on the formulations, which is set forth in Table IV below.

TABLE IV

| | Sample | | |
|---|---|---|---|
| | A | C | D |
| Rubinate M ® isocyanate | 216.59 | 227.54 | 230.28 |
| PS 2352 polyol | 100.00 | 100.00 | 100.00 |
| Water | 0.75 | 0.75 | 0.75 |
| Cyclopentane | 20.00 | 20.00 | 20.00 |
| B-8443 | 2.00 | 2.00 | 2.00 |
| Fyrol PCF | 10.00 | 10.00 | 10.00 |
| JEFFCAT ® Z-110 catalyst | 0.70 | 0.70 | 0.70 |
| PELCAT ® 9540A catalyst | 3.00 | 3.00 | 3.00 |
| JEFFCAT ®TR-63 catalyst | — | 2.00 | 2.50 |

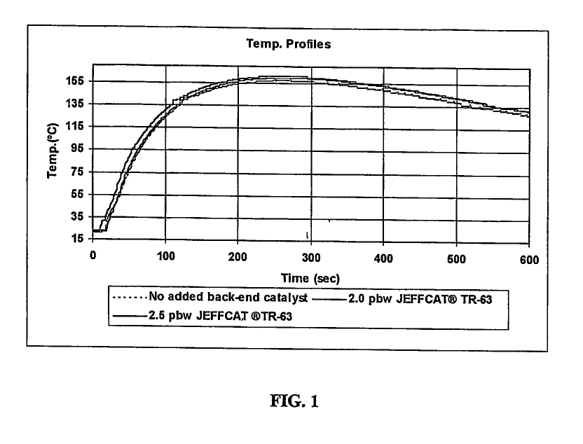

We first measured the exotherm of each system. This was done by premixing the polyol, water, cyclopentane, surfactant, flame retardant, tertiary amine, and potassium salt until a homogenous liquid resulted. A portion of this mixture was added to a one-quart mixing cup. If JEFFCAT® TR-63 catalyst would be used, as in Examples B and C, then the appropriate amount was added to the cup. The cup would be pre-mixed using a conventional stirring blade at 3000 RPM for 5 seconds followed by adding the correct amount of isocyanate to the cup. The mixture would then be mixed for 7 seconds using the 3000 RPM mixer. It would then be poured into a cup which had a thermocouple located in the center of the cup. A data acquisition system was connected to the thermocouple to record the temperature every second. This data was then used to program the heated probe on the ReactFTIR instrument. This was repeated for each catalyst combination, and the data on temperature profiles is specified in FIG. 1.

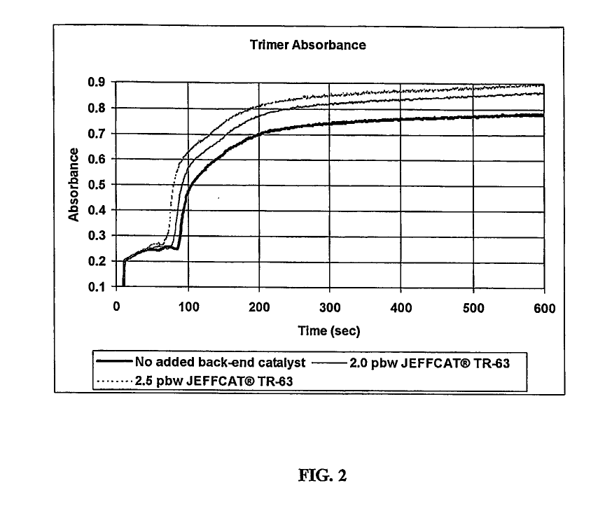

Each individual exotherm profile was used to program the heated probe on the FTIR instrument. Before we made a run on the FTIR heated probe, we put an 16-oz paper cup, with a one-inch hole in the bottom of the cup, on top of the heated probe. The paper cup was slid 1 inch below the top of the probe. We then programmed the heated probe with the temperature profile that had been collected earlier with the particular formulation. The B-component, with added catalyst, was premixed for 5 seconds using a conventional mixing blade at 3500 rpm. RUBINATE® M isocyanate was then added to the cup. When the mixer started to mix the components, the FTIR instrument was started. The foam was mixed for seven seconds and then poured on top of the heated probe such that the liquid covered the probe's top surface. FTIR data was collected for 600 seconds. During that time, hundreds of spectra were collected while the heated probe followed the heat profile programmed into it. The FTIR spectra were collected and analyzed. The top of the peaks were converted into data that was exported to an excel spreadsheet. The resulting peak profiles for the isocyanurate peak (1409 cm-1) are shown in FIG. 2. As can be seen in this graph, higher levels of JEFFCAT® TR-63 produce a foam having higher amounts of isocyanurate in the foam.

As used in the present specification and the appended claims, the term “organic isocyanate” includes a wide variety of materials recognized by those skilled in the art as being useful in preparing polyurea and polyurethane polymer materials. Included within this definition are both aliphatic and aromatic isocyanates, as well as one or more prepolymers or quasi-prepolymers prepared using such isocyanates as a starting material, as is generally well known in the art. Preferred examples of aliphatic isocyanates are of the type described in U.S. Pat. No. 4,748,192, as well as aliphatic di-isocyanates and, more particularly, the trimerized or the biuretic form of an aliphatic di-isocyanate, such as hexamethylene di-isocyanate (“HDI”), and the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate and 1,4-tetramethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate, the corresponding isomer mixtures, and the like.

A wide variety of aromatic polyisocyanates may also be used to form a polymer according to the present invention, and typical aromatic polyisocyanates include p-phenylene di-isocyanate, polymethylene polyphenylisocyanate, 2,6-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate, as well as MDI-based quasi-prepolymers such as those available commercially as RUBINATE® 9480, RUBINATE® 9484, and RUBINATE® 9495 from Huntsman International, LLC. Other aromatic polyisocyanates used in the practice of the invention are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually methylene-bridged polyphenyl polyisocyanate mixtures contain about 20 to about 100 weight percent methylene di-phenyl-di-isocyanate isomers, with the remainder being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. The present invention includes the use of mixtures of isomers of isocyanates, which are produced simultaneously in a phosgenation reaction, or any blend of two or more isocyanates (including two or more mixtures of isocyanates, or a single isocyanate with a mixture of isocyanates) which are produced using two or more separate phosgenations. One preferred aromatic polyisocyanate is methylene bis(4-phenylisocyanate) or “MDI”. Pure MDI, quasi-prepolymers of MDI, modified pure MDI, etc. are useful to prepare materials according to the invention. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. The term organic isocyanate also includes quasi-prepolymers of isocyanates or polyisocyanates with active hydrogen containing materials. Any of the isocyanates mentioned above may be used as the organic isocyanate component in the present invention, either alone or in combination with other aforementioned isocyanates.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations.

What is claimed is:

1) In a process for producing an elastomer, a PIR, or PUR foam product by reaction of an organic isocyanate and a polyol in the presence of a tertiary amine catalyst, wherein the improvement comprises conducting the reaction in the further presence of a compound which contains tris-(hydroxyethyl)methyl ammonium cation, said compound being present in an amount of at least 40% by weight, based on the weight of the tertiary amine present in the composition from which said foam product is produced.

2) A process according to claim 1 wherein the charge counterbalance for said tris-(hydroxyethyl)methyl ammonium cation is provided by the presence of an ion selected from the group consisting of: hydroxide ion, carbonate ion, bi-carbonate ion, chloride ion, bromide ion, a C₁-C₄₀ carboxylate anion, dihydrogen phosphate anion, mono-hydrogenphosphate anion, and phosphate anion.

3) A process according to claim 1 wherein said process is conducted in the presence of any amount of water between about 0.05% and 50.0% by weight based on the total weight of said polyol present.

4) A process according to claim 1 wherein said tertiary amine is selected from the group consisting of: N,N,N′-trimethyl-N′-hydroxyethyl-bisaminoethylether; bis-(2-dimethylaminoethyl)ether; N,N,N′,N″,N″-pentamethyl-dipropylenetriamine; N,N-dimethylcyclohexylamine; and pentamethyldiethylenetriamine.

5) A process according to claim 1 which is conducted in the further presence of potassium ion, present in any amount between 0.05% and 4.0% by weight, based on the total weight of the foam produced.

6) A process according to claim 1 which is conducted in the further presence of one or more materials known to those skilled in the art falling within the classes of: surfactants, flame retardants, and blowing agents when used in the production of polyurethane elastomers or polyurethane foams.

7) An aqueous solution comprising tris-(hydroxyethyl)methyl ammonium cation, water, and a tertiary amine.

8) An aqueous solution according to claim 7 wherein said tertiary amine is selected from the group consisting of: N,N,N′-trimethyl-N′-hydroxyethyl-bisaminoethylether; bis-(2-dimethylaminoethyl)ether; N,N,N′,N″,N″-pentamethyl-dipropylenetriamine; N,N-dimethylcyclohexylamine; and pentamethyldiethylenetriamine.

9) A solution comprising tris-(hydroxyethyl)methyl ammonium cation and one or more C₁-C₄₀ carboxylate anions dissolved in an organic solvent selected from the group consisting of: alcohols having between about 1 and about 20 carbon atoms; ethers having between about 1 and about 20 carbon atoms; alkylene glycols; polyalkylene glycols; glycol ethers; hydrocarbons; ketones; and esters.
